(19) United States
(12) Patent Application Publication
(10) Pub. No.: US 2001/0010721 A1
(43) Pub. Date: Aug. 2, 2001

(54) Common key generating method, common key generating apparatus, encryption method, cryptographic communication method and cryptographic communication system

(75) Inventor: Yasuyuki Murakami, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA and MASAO KASAHARA

(21) Appl. No.: 09/767,176

(22) Filed: Jan. 22, 2001

(30) Foreign Application Priority Data
Jan. 25, 2000 (JP) 2000-16359

(51) Int. Cl. H04L 9/00

(52) U.S. Cl. 380/260; 380/283; 380/277

(57) ABSTRACT

When generating a common key for use in an encryption process of encrypting a plaintext into a ciphertext and a decryption process of decrypting the ciphertext into the plaintext, components which are contained in the secret keys of one entity and correspond to other entity as a communicating party are extracted and composition of all the extracted components is performed while shifting the components to generate a common key. Thus, the common key consisting of a larger number of bits than the number of bits in each of the extracted components is generated. A common key of any size is generated by adjusting the amount of shift.

### BACKGROUND OF THE INVENTION

The present invention relates to a method and an apparatus for generating a common key for use in an encryption process of converting a plaintext into a ciphertext and a decryption process of converting the ciphertext into the plaintext, an encryption method for encrypting a plaintext by using the generated common key, a method and a system for performing cryptographic communication by using the generated common key, and a memory product/data signal embodied in carrier wave for recording/transferring an operation program of this common key generating method.

In the modern society, called a highly information-oriented society, based on a computer network, important business documents and image information are transmitted and communicated in a form of electronic information. Such electronic information cab be easily copied, so that it tends to be difficult to discriminate its copy and original from each other, thus bringing about an important issue of data integrity. In particular, it is indispensable for establishment of a highly information oriented society to implement such a computer network that meets the factors of “sharing of computer resources,” “multi-accessing,” and “globalization,” which however includes various factors contradicting the problem of data integrity among the parties concerned. In an attempt to eliminate those contradictions, encrypting technologies which have been mainly used in the past military and diplomatic fields in the human history are attracting world attention as an effective method for that purpose.

A cipher communication is defined as exchanging information in such a manner that no one other than the participants can understand the meaning of the information. In the field of the cipher communication, encryption is defined as converting an original text (plaintext) that can be understood by anyone into a text (ciphertext) that cannot be understood by the third party and decryption is defined as restoring a ciphertext into a plaintext, and cryptosystem is defined as the overall processes covering both encryption and decryption. The encrypting and decrypting processes use secret information called an encryption key and a decryption key, respectively. Since the secret decryption key is necessary in decryption, only those knowing this decryption key can decrypt ciphertexts, thus maintaining data security.

The encryption key and the decryption key may be either the same or different from each other. A cryptosystem using the same key is called a common-key cryptosystem, and DES (Data Encryption Standards) employed by the Standard Agency of the USA Commerce Ministry is a typical example. As an example of the cryptosystem using the keys different from each other, a cryptosystem called a public-key cryptosystem has been proposed. In the public-key cryptosystem, each user (entity) utilizing this cryptosystem generates a pair of encryption and decryption keys and publicizes the encryption key in a public key list, thereby keeping only the decryption key in secret. In this public-key cryptosystem, the paired encryption and decryption keys are different from each other, so that the public-key cryptosystem has a feature that the decryption key cannot be known from the encryption key with a one-way function.

The public-key cryptosystem is a breakthrough in cryptosystem which publicizes the encryption key and meets the above-mentioned three factors required for establishing highly information-oriented society, so that it has been studied actively for its application in the field of information communication technologies, thus leading RSA cryptosystem being proposed as a typical public-key cryptosystem. This RSA cryptosystem has been implemented by utilizing the difficulty of factorization into prime factors as the one-way function. Also, a variety of other public-key cryptosystems have been proposed that utilize the difficulty of solving discrete logarithm problems.

Besides, a cryptosystem has been proposed that utilizes ID (identity) information identifying individuals, such as post address and name of each entity. This cryptosystem generates an encryption/decryption key common to a sender and a receiver based on ID information. Besides, the following ID-information based cryptosystems are provided: (1) a technique which needs a preliminary communication between the sender and the receiver prior to a ciphertext communication and (2) a technique which does not need a preliminary communication between the sender and the receiver prior to a ciphertext communication. The technique (2), in particular, does not need a preliminary communication, so that its entities are very convenient in use, thus considered as a nucleus for the future cryptosystems.

A cryptosystem according to this technique (2) is called ID-NIKS (ID-based non-interactive key sharing scheme), whereby sharing an encryption key without a preliminary communication is enabled by employing ID information of a communication partner. The ID-NIKS needs not exchange a public key or a secret key between a sender and a receiver nor receive a key list or services from third parties, thus securing safe communications between any given entities.

FIG. 1 shows principles for this ID-NIKS system. This system assumes the presence of a reliable center as a key generating agency, around which a common-key generation system is configured. In FIG. 1, the information specific to an entity A, i.e. its ID information of a name, a post address, a telephone number, etc. is represented by h(ID_{A}) using a hash function h(•). For an any given entity A, the center calculates secret information S_{Ai} as follows on the basis of center public information {P_{ci}}, center secret information {SCᵢ} and ID information h(ID_{A}) of the entity A, and sends it to the entity A secretly:

S_{Ai}=Fᵢ({SCᵢ}, {PCᵢ}, h(ID_{A}))

The entity A generates, for communications between itself and another arbitrary entity B, a common key K_{AB} for encryption and decryption with its own secret {S_{Ai}}, center public information {PCᵢ} and entity B's ID information h(ID_{B}) of the partner entity B as follows:

K_{AB}=f({S_{Ai}}, {PCᵢ}, h(ID_{B}))

The entity B also generates a common key K_{BA} for the entity A similarly. If a relationship of K_{AB}=K_{BA} holds true always, these keys K_{AB} and K_{BA} can be used as the encryption and decryption keys between the entities A and B.

In the above-mentioned public-key cryptosystem, for example, an RSA cryptosystem, its public key measures 10-fold and more as long as the presently used telephone number, thus being very troublesome. To guard against this, in the ID-NIKS, each ID information can be registered in a form of name list to thereby be referenced in generating a common key used between any given entities. Therefore, by safely implementing such an ID-NIKS system as shown in FIG. 1, a convenient cryptosystem can be installed over a computer network to which a lot of entities are subscribed. For these reasons, the ID-NIKS is expected to constitute a core of the future cryptosystem.

The ID-NIKS has the following two problems. One is that the center becomes Big Brother (the center holds the secrets of all entities and functions as a Key Escrow System). Another problem is that there is a possibility that, when a certain number of entities collude with each other, they can calculate a secret of the center. While various measures have been taken to prevent the collusion problem in terms of quantity of calculation, it is difficult to completely solve this problem.

The cause of the difficulty in solving this collusion problem is that secret parameters based on identification information (ID information) have the dual structure consisting of a center secret and a private secret. In the ID-NIKS, a cryptosystem consists of a publicized parameter of the center, publicized identification information (ID information) of an individual and this two kinds of secret parameters, and it is necessary to design the cryptosystem so that, even when entities show each other their private secrets distributed to them, the center secret is not revealed. Thus, for the realization of such a cryptosystem, there are many problems to be solved.

Then, the present inventors have proposed a secret key generating method, an encryption method and a cryptographic communication method (hereinafter referred to as the “prior example”) based on the ID-NIKS, which can minimize the mathematical structure, avoid the collusion problem and readily construct the cryptosystem by dividing the identification information (ID information) into some blocks and distributing all secret keys based on the divided information (ID information) from a plurality of centers to an entity.

The reason why various types of cryptosystem based on the identification information (ID information) of an entity, which were proposed to solve the collusion problem, did not succeed was that the measures taken to prevent the center secret from being calculated from collusion information of the entities depended excessively on the mathematical structure. When the mathematical structure is too complicated, a method for verifying security also becomes difficult. Therefore, in the proposed method of the prior example, the identification information (ID information) of an entity is divided into some blocks and all the secret keys for the respective divided identification information (ID information) are distributed to the entity, thereby minimizing the mathematical structure.

In the prior example, a plurality of reliable centers are provided, and the centers generate secret keys having no mathematical structure and corresponding to the respective divided identification information (ID information) of each entity, and send the secret keys to each entity. Each entity generates a common key from the secret keys sent from the respective centers and the publicized identification information (ID information) of the communicating party, without preliminary communication. Concretely, each entity extracts the components corresponding to the communicating party which are contained in the respective secret keys and composes the extracted components, thereby generating a common key. Therefore, a single center can never hold the secrets of all entities, and each center can never become Big Brother.

Then, the present inventors are pursing their research to improve such prior examples and to construct a cryptographic communication system adopting the prior examples. For such a cryptographic communication system including a plurality of centers, it is convenient to generate a common key for use in the encryption process and the decryption process without performing preliminary communication. However, in the case where composition of components corresponding to the communicating party, contained in the respective secret keys, is performed by simply adding these components, since the number of bits in the respective components is fixed, the number of bits in the resulting common key is also fixed. Thus, this cryptographic communication system has a drawback that it is not applicable to a key sharing system for a key consisting of any number of bits, and is expected to make a further improvement.

### BRIEF SUMMARY OF THE INVENTION

An object of the present invention is to provide a common key generating method, common key generating apparatus, encryption method, cryptographic communication method and cryptographic communication system which are capable of varying the length of a common key to be generated by each entity and applicable to a key sharing system for a key consisting of any number of bits, and to provide a memory product/data signal embodied in carrier wave for recording/transferring an operation program of this common key generating method.

In the present invention, when generating a common key for use in an encryption process of encrypting a plaintext into a ciphertext and a decryption process of decrypting the ciphertext into the plaintext in cryptographic communication between entities, components, which are contained in the secret keys of one entity generated using respective divided identification information obtained by dividing the identification information of the one entity into a plurality of blocks and correspond to the other entity as a communicating party, are extracted, and each of the extracted components is subjected to conversion for increasing the number of bits thereof, and composition of the converted components is performed to generate a common key.

In the present invention, it is therefore possible to generate a common key consisting of different number of bits from the number of bits of the respective extracted components. As a composition process adopting such bit number conversion, for example, it is possible to use a shift composition process. In the case where each of the extracted components consists of n bits, the composition result obtained by simple composition of the components is n bits, and the size of the common key is fixed (n bits). Then, the present invention performs composition of a plurality of these components, each consisting of n bits, while shifting the components. By performing such shift composition, the composition result becomes m bits (m>n), and therefore a common key of m bits can be 5 generated. Besides, it is also possible to generate a common key of any size by adjusting the amount of shift.

The above and further objects and features of the invention will more fully be apparent from the following detailed description with accompanying drawings.

### BRIEF DESCRIPTION OF THE SEVERAL VIEWS OF THE DRAWINGS

FIG. 1 is an illustration showing a theoretical structure of a system of the ID-NIKS;

FIG. 2 is a schematic diagram showing the structure of a cryptographic communication system of the present invention;

FIG. 3 is a schematic diagram showing a state of information communication between two entities;

FIG. 4 is a schematic diagram showing an example of dividing an ID vector of an entity;

FIG. 5A is a schematic diagram showing a process of performing composition of components which are contained in an entity's own secret key and correspond to the other entity as a communicating party, according to a conventional example;

FIG. 5B is a schematic diagram showing a process of performing composition of components which are contained in an entity's own secret key and correspond to the other entity as a communicating party, according to an example of the present invention; and

FIG. 6 is an illustration showing the structure of an embodiment of a memory product.

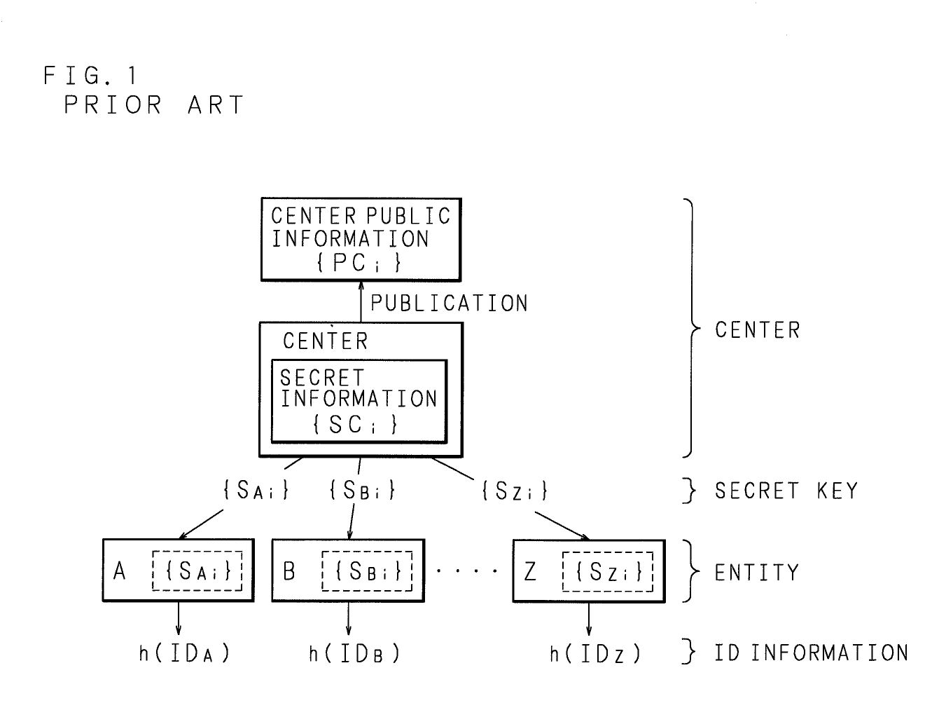

### DETAILED DESCRIPTION OF THE INVENTION

The present invention will be described in detail below with reference to the drawings illustrating the embodiment thereof.

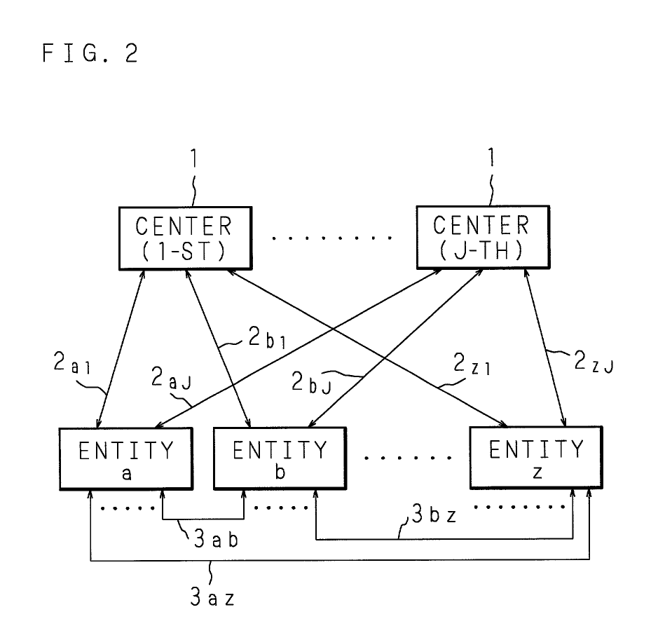

FIG. 2 is a schematic diagram showing the structure of a cryptographic communication system of the present invention. A plurality (J-number) of centers 1 as key generating agencies that can be trusted for the secrecy of information are set, and, for example, public organizations in the society can be appropriated for the centers 1.

Each of these centers 1 is connected to a plurality of entities a, b, . . . , z as the users of this cryptographic communication system via communication channels 2ₐ₁, . . . , 2_{aJ}, 2_{b1}, . . . , 2_{bJ}, . . . , 2_{z1}, . . . , 2_{zJ}, and the secret keys of the respective entities are transmitted to the entities a, b, . . . , z from the centers 1 via these communication channels, respectively. Moreover, communication channels 3ab, 3_{az}, 3_{bz}, . . . are provided between two entities so that a ciphertext given by encrypting communicating information is transmitted between the entities via the communication channels 3ab, 3az, 3bz, . . . .

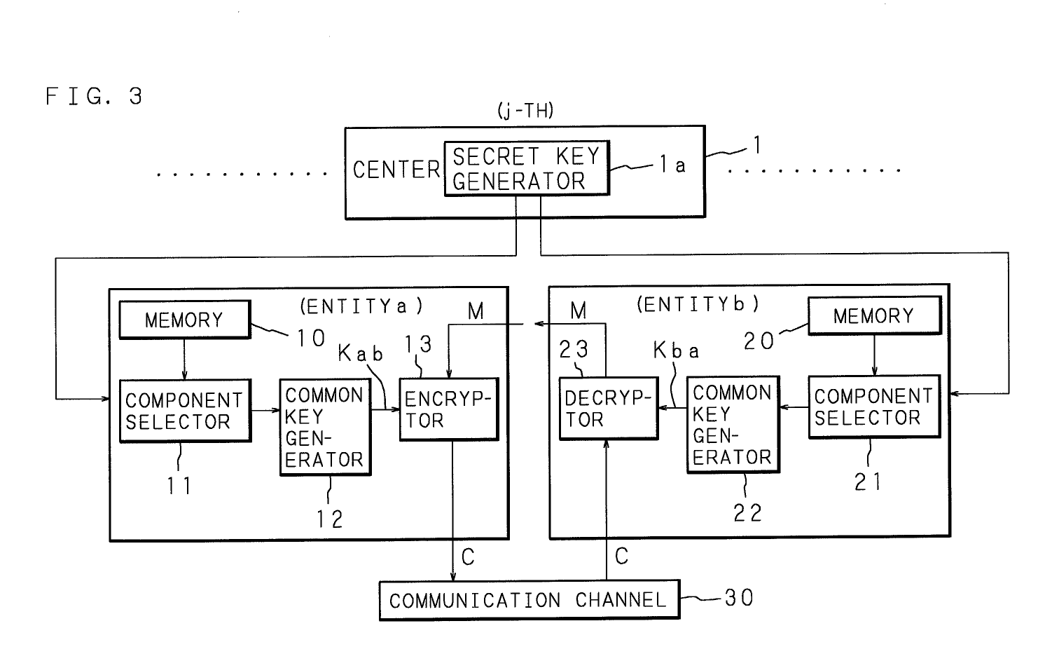

FIG. 3 is a schematic diagram showing a state of information communication between two entities, a and b. The example shown in FIG. 3 illustrates a case where the entity a encrypts a plaintext (message) M into a ciphertext C and transmits the ciphertext C to the entity b, and the entity b decrypts the ciphertext C into the original plaintext (message) M.

The j-th (j=1, 2, . . . , J) center 1 is provided with a secret key generator 1a for generating a secret key of each of the entities a and b by using the divided identification information (ID division vector) of each of the entities a and b. Upon a request for registration from the entities a and b, the secret keys of the entities a and b are sent to the entities a and b, respectively.

The entity a is provided with a memory 10 storing the secret keys sent from the J centers 1 in the form of a table; a component selector 11 for selecting components corresponding to the entity b from these secret keys; a common key generator 12 for generating a common key K_{ab}, which is desired by the entity a for use with the entity b, by performing composition of these selected components; and an encryptor 13 for encrypting the plaintext (message) M into the ciphertext C by using the common key K_{ab} and for outputting the ciphertext C to a communication channel 30.

Meanwhile, the entity b is provided with a memory 20 storing the secret keys sent from the respective centers 1 in the form of a table; a component selector 21 for selecting components corresponding to the entity a from these secret keys; a common key generator 22 for generating a common key K_{ba}, which is desired by the entity b for use with the entity a, by performing composition of these selected components; and a decryptor 23 for decrypting the ciphertext C input from the communication channel 30 into the plaintext (message) M by using the common key K_{ba} and for outputting the plaintext M.

Next, the following description will explain the operation of cryptographic communication in a cryptographic communication system having such a structure.

(Preparation Process)

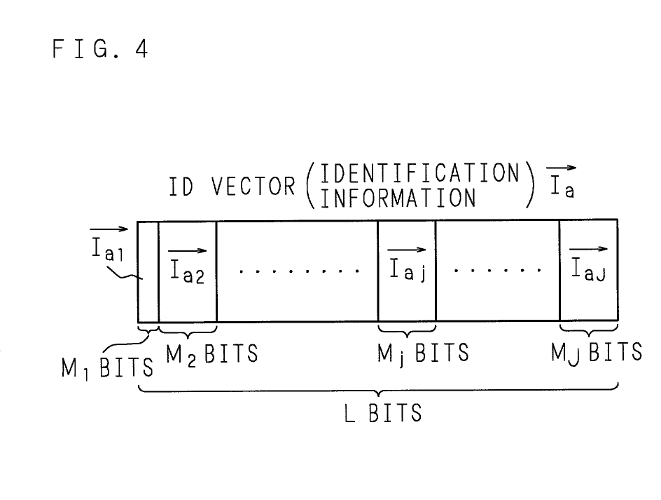

Let an ID vector as the identification information showing the name and address of each entity be an L-dimensional binary vector, and, as shown in FIG. 4, the ID vector is divided into J blocks of block sizes M₁, M₂, . . . , M_{J}. For example, the ID vector (vector Iₐ) of the entity a is divided as shown by equation (1) below. Each vector Iₐⱼ (j=1, 2, . . . , J) as the divided identification information is referred to as an “ID division vector”. Here, when Mⱼ=M, all the ID division vectors have an equal size. Besides, it is also possible to set Mⱼ=1. Further, a publicized ID vector of each entity is converted into L bits by a hash function.

$$\vec{{I}_{a}} = [ \vec{{I}_{a1}} \vert \vec{{I}_{a2}} \vert … \vert \vec{{I}_{aJ}} ] \qquad ( 1 )$$

(Secret Key Generating Process (Registration of Entity))

Each center 1 requested by the entity a to register the entity a generates a secret key (later-described secret key vector) of the entity a at the secret key generator 1a by using the ID division vector of the entity a and the center's own secret information (later-described symmetric matrix), and transmits the generated secret key to the entity a to complete the registration.

Here, the following description will explain specifically the contents of the secret information (symmetric matrix) at each center 1 and the secret keys (secret key vectors) of each entity. The j-th (j= 1, 2, . . . , J) center 1 has a symmetric matrix Hⱼ (2^{Mj}×2^{Mj}) having random numbers as components. Besides, the j-th center 1 issues for each entity the row vector of the symmetric matrix Hⱼ that corresponds to the ID division vector of that entity as the secret key (secret key vector). More specifically, Hⱼ [vector Iₐⱼ] is issued for the entity a. This Hⱼ [vector Iₐⱼ] denotes the vector of one row corresponding to the vector Iₐⱼ extracted from the symmetric matrix Hⱼ.

(Common Key Generating Process between Entities)

The entity a (entity b) reads from the memory 10 (20) its own secret vectors (secret keys) sent from the J centers 1 and extracts components corresponding to the entity b (entity a) from the read secret vectors (secret keys) at the component selector 11 (21), and performs composition of these J components at the common key generator 12 (22) to generate the common key K_{ab} (K_{ba}) of the entity a (entity b) for use with the entity b (entity a). Here, the common keys K_{ab} and K_{ba} are identical with each other, based on the symmetry property of the secret information (matrices) held at the J centers 1.

(Creation of Ciphertext at Entity a and Decryption of the Ciphertext at Entity b)

At the entity a, a plaintext (message) M is encrypted into a ciphertext C at the encryptor 13 by using the common key K_{ab} generated at the common key generator 12, and the ciphertext C is transmitted to the entity b via the communication channel 30. At the entity b, the ciphertext C is decrypted into the original plaintext (message) M at the decryptor 23 by using the common key K_{ba} generated at the common key generator 22.

Here, the following description will explain the generation of a common key at each entity, which is a characteristic feature of the present invention, and particularly the composition of components corresponding to the other entity as the communicating party, contained in the entity's own secret keys.

Since each entity can perform composition of components in any manner in generating a common key, if each entity converts the components corresponding to the communicating party in its already obtained secret keys to increase the size (the number of bits) of the components and then performs composition of these components, it is possible to increase the size of a common key to be generated. More specifically, each of the j-th centers 1 publicizes a function Fⱼ for converting S bits into S′ bits, and the entity a generates the common key K_{ab} for use with the entity b according to equation (2) below. Here, K_{ajbj}^{(j)} denotes a component corresponding to the entity b in the secret vector (secret key) of the entity a.

$${K}_{ab} = {F}_{1} ( {k}_{{a}_{1} {b}_{1}}^{( 1 )} ) ⊕ {F}_{2} ( {k}_{{a}_{2} {b}_{2}}^{( 2 )} ) ⊕ … ⊕ {F}_{J} ( {k}_{{a}_{J} {b}_{J}}^{( J )} ) \qquad ( 2 )$$

For such conversion to increase the common key, it is possible to use a variety of methods. However, in order to prevent impairment of the characteristic of the present invention which relies on the system having no complicated mathematical structure, it is deemed preferable to perform simple conversion using shift composition (bit rotation) or the like. For instance, in order to generate a common key of 128 bits from components, each consisting of 64 bits, <<n is defined as left rotation by n bits (the overflow from a high order position returning to a low order position) for a 128-bit register, and the common key K_{ab} is generated according to equation (3) below.

$${K}_{ab} = {K}_{{a}_{1} {b}_{1}}^{( 1 )} ⊕ ( {k}_{{a}_{2} {b}_{2}}^{( 2 )} ⪡ 32 ) ⊕ ( {k}_{{a}_{1} {b}_{1}}^{( 1 )} ⪡ 64 ) ⊕ ( {k}_{{a}_{2} {b}_{2}}^{( 2 )} ⪡ 96 ) \qquad ( 3 )$$

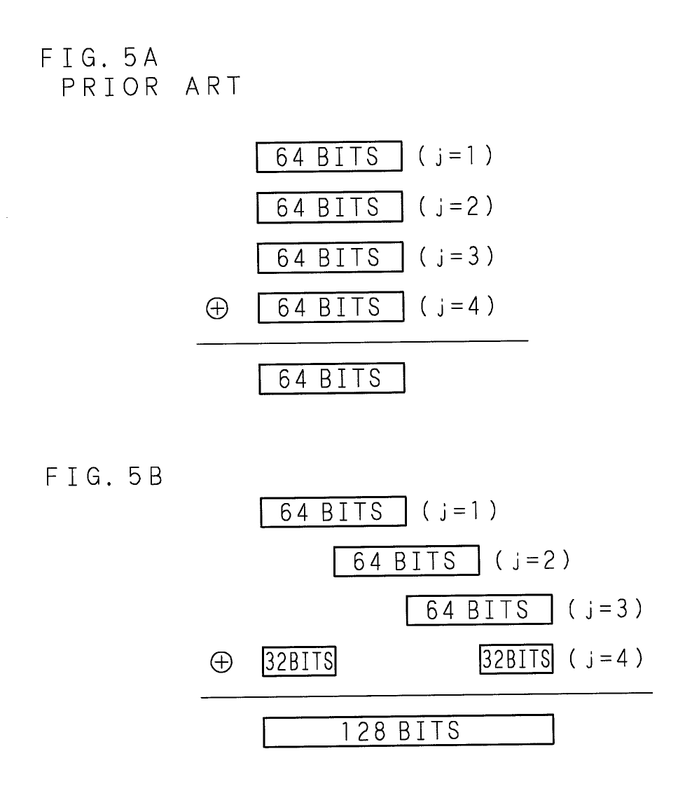

A specific example of such a “shift composition” process will be explained. In the example illustrated below, let the number of bits in each of the components subjected to composition be 64 bits, and the number of the centers 1 be four (J=4). In the case where composition is performed by simply adding the four 64-bit components, as shown in FIG. 5A, the composition result is 64 bits. Hence, this is applicable to a 64-bit key sharing system, but it is not applicable to a key sharing system for a key consisting of different number of bits. Then, in the present invention, as shown in FIG. 5B, composition is performed by adding these four 64-bit components while shifting the components. For instance, in the example shown in FIG. 5B, the components are shifted so that the composition result is 128 bits, thereby generating a 128-bit common key. Thus, even when each of the components consists of 64 bits, the present invention is applicable to a 128-bit key sharing system.

Besides, since the amount that each component is shifted can be set arbitrarily, the amount of shift will be set according to the number of bits of a key sharing system to which the present invention is applied. Hence, a common key of any size can be generated by performing such a shift composition process, and the present invention is applicable to a key sharing system for a key consisting of any number of bits. Furthermore, in this shift addition composition process, when the shift position is set so as to delete a random number from each position, the present invention is also applicable to an encryption system in which random numbers are added.

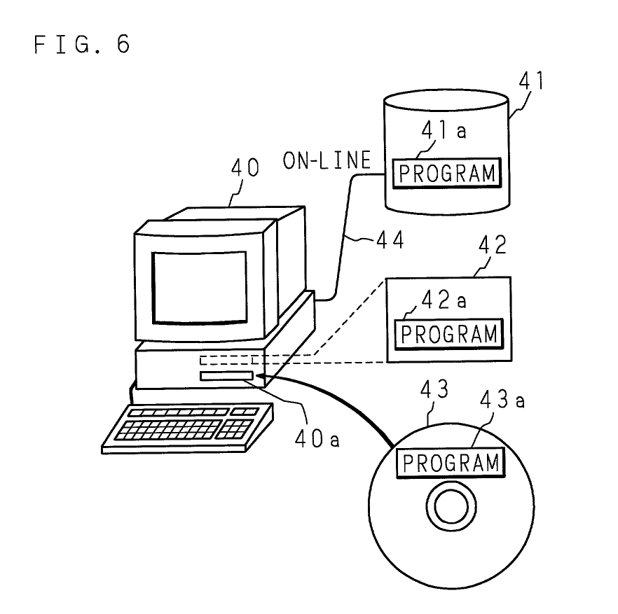

FIG. 6 is an illustration showing the structure of an embodiment of a memory product of the present invention. The program illustrated as an example here includes processes performed at each entity for extracting components corresponding to the other entity as the communicating party from its own secret keys and for performing shift composition of the extracted components to generate a common key for use in encryption and decryption, and is recorded on a memory product as to be explained below. Besides, a computer 40 is provided for each entity.

In FIG. 6, a memory product 41 to be on-line connected to the computer 40 is implemented using a server computer, for example, WWW (World Wide Web), located in a place distant from the installation location of the computer 40, and a program 41a as mentioned above is recorded on the memory product 41. The program 41a read from the memory product 41 via a transfer medium 44 such as a communication channel controls the computer 40 so as to generate a common key at each entity.

A memory product 42 provided inside the computer 40 is implemented using, for example, a hard disk drive, a ROM or the like to be installed in the computer 40, and a program 42a as mentioned above is recorded on the memory product 42. The program 42a read from the memory product 42 controls the computer 40 so as to generate a common key at each entity.

A memory product 43 used by being loaded into a disk drive 40a installed in the computer 40 is implemented using, for example, a removable magneto-optical disk, CD-ROM, flexible disk or the like, and a program 43a as mentioned above is recorded on the memory product 43. The program 43a read from the memory product 43 controls the computer 40 so as to generate a common key at each entity.

As described above, in the present invention, when generating a common key for use in an encryption process of encrypting a plaintext into a ciphertext and a decryption process of decrypting the ciphertext into the plaintext, since the components, which are contained in the respective secret-keys of one entity and correspond to the other entity as the communicating party, are extracted, and composition of the extracted components is performed while shifting the components. Therefore, the present invention can generate a common key of any size and is applicable to a key sharing system for a key consisting of any number of bits. Accordingly, the present invention can greatly contribute to the development of a cryptographic communication system based on the ID-NIKS.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A common key generating method for generating a common key for use in an encryption process of encrypting a plaintext into a ciphertext and a decryption process of decrypting the ciphertext into the plaintext in cryptographic communication between entities, comprising the steps of:
dividing identification information of one entity into a plurality of blocks to obtain divided identification information;
generating secret keys of the one entity by using the respective divided identification information;
extracting components corresponding to other entity as a communicating party from the generated secret keys of the one entity; and
generating a common key by performing composition of the extracted components after converting the extracted components to increase the number of bits thereof.

2. The common key generating method as set forth in claim 1,
wherein a shift composition is used in performing composition of the extracted components after converting the extracted components to increase the number of bits thereof.

3. A common key generating apparatus, provided for an entity in a cryptographic communication system, for generating a common key for use in an encryption process of encrypting a plaintext into a ciphertext and a decryption process of decrypting the ciphertext into the plaintext, comprising
a controller capable of performing the following operations:
(i) extracting, from secret keys of the entity generated using respective divided identification information obtained by dividing identification information of the entity into a plurality of blocks, components corresponding to other entity as a communicating party; and
(ii) generating a common key by performing composition of the extracted components after converting the extracted components to increase the number of bits thereof.

4. The common key generating apparatus as set forth in claim 3,
wherein a shift composition is used in performing composition of the extracted components after converting the extracted components to increase the number of bits thereof.

5. An encryption method for encrypting into a ciphertext a plaintext to be transmitted from a first entity to a second entity, comprising the steps of:
generating secret keys of the first entity by using respective divided identification information obtained by dividing identification information of the first entity into a plurality of blocks;
generating a common key by extracting components corresponding to the second entity from the generated secret keys and performing composition of the extracted components after converting the extracted components to increase the number of bits thereof; and
encrypting the plaintext into the ciphertext by using the generated common key.

6. A cryptographic communication method for communicating information by a ciphertext between first and second entities, comprising the steps of:
sending secret keys generated using respective divided identification information obtained by dividing identification information of each entity into a plurality of blocks to each of the first and second entities from a plurality of key generating agencies;
at the first entity, generating a first common key by extracting components corresponding to the second entity as a destination of the ciphertext from the respective secret keys of the first entity sent from the respective key generating agencies and performing composition of the extracted components after converting the extracted components to increase the number of bits thereof;
at the first entity, encrypting a plaintext into a ciphertext by using the generated first common key and transmitting the ciphertext to the second entity;
at the second entity, generating a second common key identical with the first common key by extracting components corresponding to the first entity from the respective secret keys of the second entity sent from the respective key generating agencies and performing composition of the extracted components after converting the extracted components to increase the number of bits thereof; and
at the second entity, decrypting the transmitted ciphertext into a plaintext by using the generated second common key.

7. The cryptographic communication method as set forth in claim 6,
wherein a shift composition is used at the first and second entities in performing composition of the extracted components after converting the extracted components to increase the number of bits thereof.

8. A cryptographic communication system for performing an encryption process of encrypting a plaintext as information to be transmitted into a ciphertext and a decryption process of decrypting the transmitted ciphertext into a plaintext mutually between a plurality of entities, comprising:
a plurality of key generating agencies, each of which generates a secret key of each entity, by using each of respective divided identification information obtained by dividing identification information of each entity into a plurality of blocks and for transmitting the generated secret key to each entity; and
a plurality of entities, each of which generates a common key for use in the encryption process and decryption process by extracting components corresponding to other entity as a communicating party from its own secret keys sent from the key generating agencies and performing composition of the extracted components after converting the extracted components to increase the number of bits thereof.

9. A computer memory product having computer readable program code means for causing a computer to generate a common key for use in an encryption process of encrypting a plaintext into a ciphertext and a decryption process of decrypting the ciphertext into the plaintext in cryptographic communication between entities, said computer readable program code means comprising:
program code means for causing the computer to extract from secret keys of one entity, which were generated using respective divided identification information obtained by dividing identification information of the one entity into a plurality of blocks, components corresponding to other entity as a communicating party; and
program code means for causing the computer to generate a common key by performing composition of the extracted components after converting the extracted components to increase the number of bits thereof.

10. A computer data signal embodied in a carrier wave for transmitting a program, the program being configured to cause a computer to generate a common key for use in an encryption process of encrypting a plaintext into a ciphertext and a decryption process of decrypting the ciphertext into the plaintext in cryptographic communication between entities, comprising:
a code segment for causing the computer to extract from secret keys of one entity, which were generated using respective divided identification information obtained by dividing identification information of the one entity into a plurality of blocks, components corresponding to other entity as a communicating party; and
a code segment for causing the computer to generate a common key by performing composition of the extracted components after converting the extracted components to increase the number of bits thereof.
